(19) United States
(12) Patent Application Publication
(10) Pub. No.: US 2025/0153046 A1
(43) Pub. Date: May 15, 2025

(54) ITEM SELECTION METHOD AND APPARATUS IN VIRTUAL ENVIRONMENT, DEVICE, AND MEDIUM

(71) Applicant: Tencent Technology ( Shenzhen) Company Limited, Shenzhen (CN)

(72) Inventor: Xiaodong SHI, Shenzhen (CN)

(21) Appl. No.: 19/008,318

(22) Filed: Jan. 2, 2025

Related U.S. Application Data
(63) Continuation of application No. PCT/CN2023/128970, filed on Nov. 1, 2023.

(30) Foreign Application Priority Data
Jan. 10, 2023 (CN) 202310033552.1

(51) Int. Cl. A63F 13/537

(52) U.S. Cl. CPC A63F 13/537

(57) ABSTRACT

This application relates to an item selection method and apparatus in a virtual environment performed by a computer device. The method includes: displaying a virtual object in a virtual environment; in response to a first item selection operation of the virtual object, displaying an item recommendation scheme for the virtual object under a first scheme label, the item recommendation scheme comprising a plurality of candidate recommendation schemes, at least one of the candidate recommendation schemes comprising a strategy view control, and the strategy view control being linked to a player community; and in response to a selection operation performed on the strategy view control of a target recommendation scheme, displaying a scheme strategy of the target recommendation scheme in the player community, the target recommendation scheme being any candidate recommendation scheme in the item recommendation scheme that comprises the strategy view control.

### CROSS-REFERENCE TO RELATED APPLICATIONS

This application is a continuation application of PCT Patent Application No. PCT/CN2023/128970, entitled “ITEM SELECTION METHOD AND APPARATUS IN VIRTUAL ENVIRONMENT, DEVICE, AND MEDIUM” filed on Nov. 1, 2023, which claims priority to Chinese Patent Application No. 202310033552.1, “ITEM SELECTION METHOD AND APPARATUS IN VIRTUAL ENVIRONMENT, DEVICE, AND MEDIUM” filed on Jan. 10, 2023, both of which are incorporated herein by reference in their entirety.

### FIELD OF THE TECHNOLOGY

This application relates to the field of human-machine interaction, and in particular, to an item selection method and apparatus in a virtual environment, a device, and a medium.

### BACKGROUND OF THE DISCLOSURE

A battle preparation system may be set up in a game, and a player may select an item scheme such as a battle item and talent of a virtual object through the battle preparation system before a battle or during selection of the virtual object.

In the related art, a player may learn item schemes of different virtual objects in some player communities, and then select the item scheme in the battle preparation system of the game.

### SUMMARY

This application provides an item selection method and apparatus in a virtual environment, a device, and a medium. The technical solutions are as follows.

According to an aspect of this application, an item selection method in a virtual environment is performed by a computer device, and the method including:
displaying a virtual object in the virtual environment:
in response to a first item selection operation of the virtual object, displaying an item recommendation scheme for the virtual object under a first scheme label, the item recommendation scheme comprising a plurality of candidate recommendation schemes, at least one of the candidate recommendation schemes comprising a strategy view control, and the strategy view control being linked to a player community; and
in response to a selection operation performed on the strategy view control of a target recommendation scheme, displaying a scheme strategy of the target recommendation scheme in the player community, the target recommendation scheme being any candidate recommendation scheme in the item recommendation scheme that comprises the strategy view control.

According to another aspect of this application, a computer device is provided, the computer device including: a processor and a memory, the memory having computer programs stored therein, the computer programs being loaded and executed by the processor to cause the computer device to implement the item selection method in a virtual environment as described above.

According to another aspect of this application, a non-transitory computer-readable storage medium is provided, the non-transitory computer-readable storage medium having a computer program stored therein, the computer program being loaded and executed by a processor to cause the processor to implement the item selection method in a virtual environment as described above.

Through the method, apparatus, device, and medium in the embodiments of this application, the battle preparation system for item selection in a game is coupled with a player community. When a player selects an item recommendation scheme for a virtual object, the player may directly enter the player community through the strategy view control in the battle preparation system to learn the strategy of the corresponding item recommendation scheme, which effectively improves association between the battle preparation system and the player community in the game, enriches diversity of gameplay for item selection in the game, and helps improve game experience of the player and thus increase a human-machine interaction rate.

### BRIEF DESCRIPTION OF THE DRAWINGS

FIG. 1 is a structural block diagram of a computer system according to an exemplary embodiment.

FIGS. 2A and 2B are schematic diagrams of an item selection method in a virtual environment according to an exemplary embodiment.

FIG. 3 is a flowchart of an item selection method in a virtual environment according to an exemplary embodiment.

FIG. 4 is a flowchart of an item selection method in a virtual environment according to an exemplary embodiment.

FIG. 5 is a flowchart of an item selection method in a virtual environment according to an exemplary embodiment.

FIG. 6 is a schematic diagram of an item selection method in a virtual environment according to an exemplary embodiment.

FIG. 7 is a schematic diagram of an item selection method in a virtual environment according to an exemplary embodiment.

FIG. 8 is a schematic diagram of an item selection method in a virtual environment according to an exemplary embodiment.

FIG. 9 is a flowchart of an item selection method in a virtual environment according to an exemplary embodiment.

FIG. 10 is a schematic diagram of an item selection method in a virtual environment according to an exemplary embodiment.

FIG. 11 is a structural block diagram of an item selection apparatus in a virtual environment according to an exemplary embodiment.

FIG. 12 is a structural block diagram of a computer device according to an exemplary embodiment.

### DESCRIPTION OF EMBODIMENTS

To make objectives, technical solutions, and advantages of this application clearer, implementations of this application are to be further described in detail below with reference to the accompanying drawings.

Exemplary embodiments are to be described herein in detail, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of an apparatus and a method which are consistent with some aspects of this application described in detail in the attached claims.

Terms used in this application are merely intended to describe the specific embodiments but are not intended to limit this application. Singular forms of “a”, “said”, and “the” used in this application and the appended claims are also intended to include plural forms, unless the context clearly indicates otherwise. It is to be further understood that the term “and/or” used herein indicates and includes any or all possible combinations of one or more associated listed items.

In this application, a prompt interface or a pop-up window may be displayed, or voice prompt information may be outputted before collection of user-related data (for example, prompt information of an item recommendation scheme, a scheme strategy, and an item in a player community) and during the collection of the user-related data. The prompt interface, the pop-up window, or the voice prompt information is configured for prompting the user that user-related data is currently being collected. In this way, in this application, a related operation of obtaining the user-related data only starts to be performed after a confirm operation performed by the user on the prompt interface or the pop-up window is obtained. Otherwise (i.e., when the confirm operation performed by the user on the prompt interface or the pop-up window has not been obtained), the related operation of obtaining the user-related data is ended, i.e., the user-related data is not obtained. In other words, all user data collected in this application is collected with the consent and authorization of users, and the collection, use, and processing of relevant user data need to comply with relevant laws, regulations, and standards of relevant countries and regions.

It is to be understood that although terms “first.” “second,” and the like may be used to describe various information in this application, such information is not limited to these terms. These terms are merely used to distinguish between information of the same type. For example, without departing from the scope of this application, a first parameter may also be referred to as a second parameter. Similarly, the second parameter may also be referred to as a first parameter. Depending on the context, for example, the word “if” used herein may be interpreted as “at” or “when,” or “in response to a determination”.

Terms involved in embodiments of this application are briefly described.

Virtual environment. It is a virtual environment displayed or provided w % ben a client runs on a terminal. The virtual environment may be a simulated world of a real world, or may be a semi-simulation and semi-fiction three-dimensional world, and may further be a purely fictional three-dimensional world. The virtual environment may be any one of a two-dimensional virtual environment, a 2.5-dimensional virtual environment, and a three-dimensional virtual environment. In some embodiments, the virtual environment is further configured for a virtual environment battle between at least two virtual objects, and there are virtual resources available for use by the at least two virtual objects in the virtual environment. In some embodiments, the virtual environment includes a lower left corner area and an upper right corner area that are symmetrical, and virtual objects belonging to two rival camps each occupy one area.

Virtual object: It is a movable object in a virtual environment. The movable object may be at least one of a virtual character, a virtual animal, or a cartoon character. In some embodiments, when the virtual environment is the three-dimensional virtual environment, the virtual object may be a three-dimensional virtual model. Each virtual object has a shape and a volume in the virtual environment, and occupies a part of space in the virtual environment. In some embodiments, the virtual object is a three-dimensional character constructed based on a three-dimensional human skeleton technology. The virtual object implements a different external image by wearing a different skin. In some implementations, the virtual object may also be implemented by using a 2.5-dimensional model or 2-dimensional model, which is not limited in the embodiments of this application.

Multiplayer online battle arena (MOBA): It refers to a game in which different virtual teams belonging to at least two rival camps occupy respective map regions and battle with each other for a victory condition in a virtual environment. The victory condition includes but is not limited to at least one of occupying a stronghold or destroying a rival camp stronghold, killing a virtual character of a rival camp, ensuring survival in a specified scene and specified time, snatching a resource, and getting a higher score than an opponent in specified time. A MOBA may be played in rounds. A map for each MOBA may be the same or different. Each virtual team includes one or more virtual characters, for example, 1, 2, 3, or 5 virtual characters. Exemplarily, a virtual character may also be referred to as a virtual object.

MOBA game: It is a game in which several strongholds are provided in a virtual environment, and users in different camps control virtual characters to battle in the virtual environment, occupy strongholds or destroy strongholds of a rival camp. For example, in a MOBA game, users may be divided into two rival camps, virtual characters controlled by the users are scattered in the virtual environment to compete with each other, and a victory condition is to destroy or occupy all strongholds of the rival camp. The MOBA game is played in rounds. A duration of each round of the MOBA game is from the start of the game to a moment the victory condition is met.

Battle preparation system: It is a peripheral system provided in a virtual environment. A player may adjust an item of a virtual object such as a battle item, inscription, skill, or talent through the battle preparation system before a battle or during selection of the virtual object.

Player community: It is also referred to as a micro-community, which is a built-in community in a virtual environment. The player community mainly includes content such as game strategies. In some embodiments, the player community may further be a community provided by a third-party computer device.

Key opinion leader (KOL): The KOL is a person that possesses more and more accurate product information, is accepted or trusted by a relevant group, and has great influence on behavior of the group. For a MOBA game, the KOL is mostly a live streamer or a professional player.

In response to: The expression “in response to” is configured for indicating a condition or a state on which one or more to-be-performed operations depend. When the condition or the state on which the one or more to-be-performed operations depend is met, the one or more operations may be performed in real time or with a set delay. Unless otherwise specified, a sequence in which a plurality of operations are performed is not limited.

A battle preparation system may be set up in a game (for example, a MOBA game), and a player may select an item scheme of a virtual object such as a battle item or talent through the battle preparation system before a battle or during selection of the virtual object.

In the related art, a player may learn item schemes of different virtual objects in some player communities, and then select the item scheme in the battle preparation system of the game. However, due to the low association between the battle preparation system and the player community in the game in the related art, the player can only exit from the player community and then enter the battle preparation system, or exit from the battle preparation system and then enter the player community. Item selection is weakly associated with strategy learning, and gameplay for the item selection is limited, which easily reduce game experience of a player, and thus reduce a human-machine interaction rate.

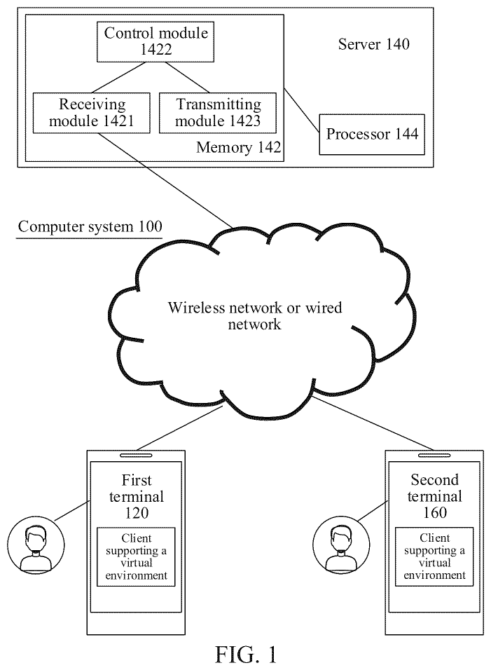

FIG. 1 is a structural block diagram of a computer system according to an exemplary embodiment of this application. The computer system may become a system architecture for implementing an item selection method in a virtual environment. The computer system 100 includes a first terminal 120, a server 140, and a second terminal 160.

The first terminal 120 has a client supporting a virtual environment installed and running therein. Exemplarily, the client may be any one of a game client, a virtual reality (VR) client, an augmented reality (AR) program, and a three-dimensional map program. Exemplarily, the game client may include but is not limited to a VR game, an AR game, a first-person shooter (FPS) game, a third-personal shooter (TPS) game, a MOBA game, and a simulation game (SLG).

The first terminal 120 is a terminal used by a first user. The first user uses the first terminal 120 to control a first virtual object located in the virtual environment. The controlling includes but is not limited to at least one of adjusting a body posture, crawling, walking, running, riding, jumping, driving, pickup, shooting, attacking, throwing, and constructing a virtual building.

The first user may further use the first terminal 120 to perform item selection on the first virtual object. The item selection includes selecting to use the overall item recommendation scheme, or individually selecting to use one or more items. In some embodiments, when the first user selects the overall item recommendation scheme of the first virtual object through the first terminal 120 and clicks/taps a strategy view control corresponding to the item recommendation scheme, the first terminal 120 may further directly display a scheme strategy in a player community. In a case that the first user individually selects to use one or more items through the first terminal 120, the first terminal 120 may further display a prompt information about the item. Exemplarily, the prompt information may be a one-sentence prompt information.

The first terminal 120 is connected to the server 140 through a wireless network or a wired network.

The server 140 may be an independent physical server, or may be a server cluster formed by a plurality of physical servers or a distributed system, and may further be a cloud server providing basic cloud computing services such as a cloud server providing a cloud computing service, a cloud database, cloud computing, a cloud function, cloud storage, a network service, cloud communication, a middleware service, a domain name service, a security service, a content delivery network (CDN), a big data and artificial intelligence (AI) platform. The server 140 includes at least one of one server, a plurality of servers, a cloud computing platform, and a virtualization center.

Exemplarily, the server 140 includes a processor 144 and a memory 142. The memory 142 further includes a receiving module 1421, a control module 1422, and a transmitting module 1423. The receiving module 1421 is configured to receive a request transmitted by a client, for example, a first view request to view an item recommendation scheme, or a second view request to view a scheme strategy of a target recommendation scheme. The control module 1422 is configured to control rendering of a virtual environment picture. The transmitting module 1423 is configured to transmit a response to a client, for example, transmitting the item recommendation scheme to the client, or transmitting the scheme strategy of the target recommendation scheme to the client. The server 140 is configured to provide a background service for the clients of the first terminal 120 and the second terminal 160. In some embodiments, the server 140 is in charge of primary computing, and the first terminal 120 and the second terminal 160 are in charge of secondary computing. Alternatively, the server 140 is in charge of secondary computing, and the first terminal 120 and the second terminal 160 are in charge of primary computing. Alternatively, the server 140, the first terminal 120, and the second terminal 160 perform collaborative computing by using a distributed computing architecture.

The second terminal 160 has a client supporting a virtual environment installed and running therein. The client may be any one of a game client, a VR client, an AR program, and a three-dimensional map program. Exemplarily, the game client may include but is not limited to a VR game, an AR game, a first-person shooter (FPS) game, a third-personal shooter (TPS) game, a MOBA game, and a simulation game (SLG).

The second terminal 160 is a terminal used by a second user. The second user uses the second terminal 160 to control a second virtual object located in the virtual environment. The controlling includes but is not limited to at least one of adjusting a body posture, crawling, walking, running, riding, jumping, driving, pickup, shooting, attacking, throwing, and constructing a virtual building.

The second user may further use the second terminal 160 to perform item selection on the second virtual object. The item selection includes selecting to use the overall item recommendation scheme, or individually selecting to use one or more items. In some embodiments, when the second user selects the overall item recommendation scheme of the second virtual object through the second terminal 160 and clicks/taps a strategy view control corresponding to the item recommendation scheme, the second terminal 160 may further directly display a scheme strategy in a player community. In a case that the second user individually selects to use one or more items through the second terminal 160, the second terminal 160 may further display a prompt information about the item. Exemplarily, the prompt information may be a one-sentence prompt information.

In some embodiments, the virtual object controlled by the first user through the first terminal 120 and the virtual object controlled by the second user through the second terminal 160 are located in different positions in the same virtual environment. To be specific, the first user and the second user are in the same battle.

In some embodiments, the client installed in the first terminal 120 is same as the client installed in the second terminal 160, or the clients installed in the two terminals are clients of the same type on different control system platforms. In the embodiments of this application, a form of the client installed on the first terminal 120 and the client installed on the second terminal 160 is not limited, including but not limited to application (App) clients installed in the first terminal 120 and the second terminal 160, an embedded program, and the like, and may further be a form of a website. The first terminal 120 may generally refer to one of a plurality of terminals, and the second terminal 160 may generally refer to one of a plurality of terminals. In this embodiment, only the first terminal 120 and the second terminal 160 are used as an example for description. The first terminal 120 and the second terminal 160 are of the same device type, or may be of different device models. The device type includes at least one of a smartphone, a tablet computer, a wearable device, a personal computer (PC), a portable laptop computer, and a desktop computer. In the following embodiment, an example in which a terminal includes a smartphone is used for description.

A person skilled in the art may understand that more or fewer terminals may be provided. For example, only one terminal (namely, a user and AI play a battle) may be provided, or 8 terminals (1v1v1v1v1v1v1v1, a round robin and an elimination match are performed among 8 users, and a winner is finally determined) may be provided, or a larger quantity of terminals are provided. A quantity of terminals and the device type are not limited in the embodiments of this application.

In the embodiments of this application, an example in which the client supporting a virtual environment is a MOBA game is used for description.

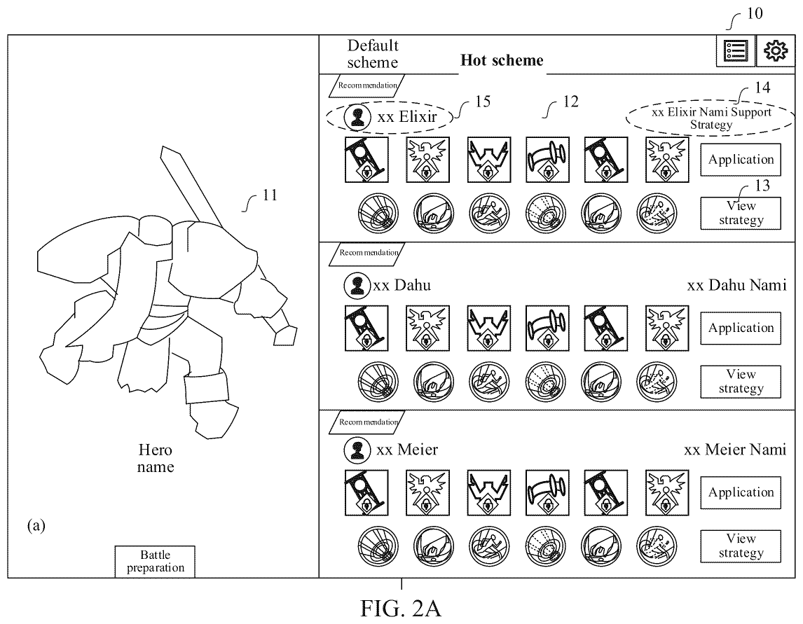

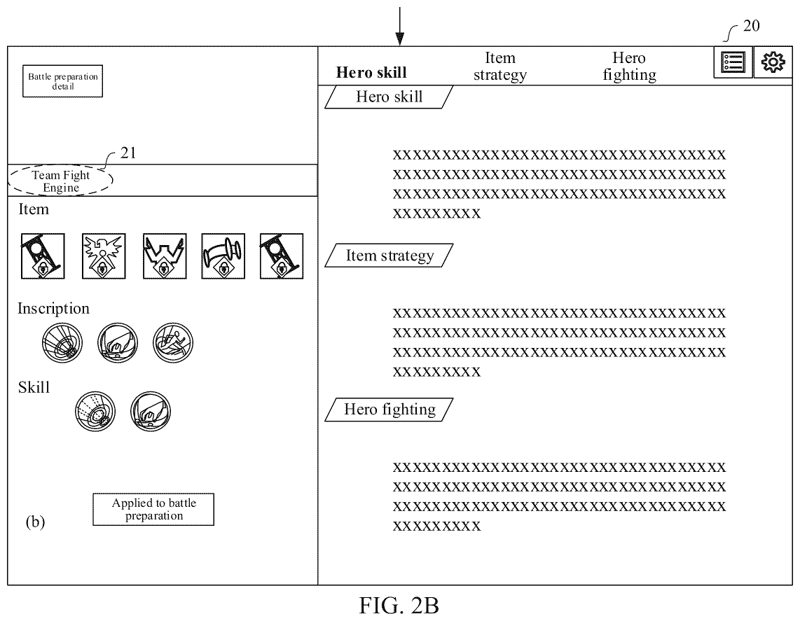

FIGS. 2A and 2B schematic diagrams of an item selection method in a virtual environment according to an exemplary embodiment of this application. An example in which the virtual environment is a virtual environment in a MOBA game and a virtual object is a virtual object in the MOBA game is used. In some embodiments, a virtual object in a game may further be referred to as a hero in the game.

The MOBA game is provided with a battle preparation system for a player to select an item such as a battle item, inscription, skill, or talent of the virtual object. The MOBA game is further provided with a player community, which is also referred to as a micro-community. The player community mainly includes content such as game strategies. In some embodiments, the player community may further be a community provided by a third-party computer device.

The method provided in the embodiments of this application may be performed by a computer device. For example, the computer device may be the first terminal 120 in FIG. 1, or may be the second terminal 160 in FIG. 1, and may further be another terminal. Operations of the item selection method in a virtual environment in the embodiments of this application are as follows; operation 1 to operation 3.

1. Display a virtual object in a virtual environment.

As shown in part (a) of FIG. 2A, a virtual object 11 in a virtual environment 10 is displayed. The virtual object 11 is a virtual object on which item selection needs to be performed.

2. Display an item recommendation scheme for the virtual object under a first scheme label in response to a first item selection operation of the virtual object, the item recommendation scheme including a plurality of candidate recommendation schemes, at least one of the candidate recommendation schemes including a strategy view control, the strategy view control being linked to a player community.

The first item selection operation is an operation of performing item selection through a battle preparation system. Exemplarily, the first item selection operation is an operation of performing item selection of a virtual object through a battle preparation system in a MOBA game.

The battle preparation system includes a default scheme label and a hot scheme label. Under the default scheme label are generally officially recommended item schemes for the game, and under the hot scheme label are generally player-recommended item schemes.

In an exemplary embodiment, when the battle preparation system is started, when content data exists under the hot scheme label, the content data under the hot scheme label is displayed by default. In this way, the item scheme recommended by the players can be recommended to a current player, which helps improve diversity of item selection, improve game experience of the current player, and thus increase the human-machine interaction rate.

As shown in part (a) of FIG. 2A, a virtual object 11 in a virtual environment 10 is displayed. An item recommendation scheme for the virtual object under a hot scheme label is displayed in response to a first item selection operation of the virtual object 11.

The item recommendation scheme includes a plurality of candidate recommendation schemes 12, at least one of the candidate recommendation schemes 12 including a strategy view control 13, the strategy view control 13 being linked to a player community. Information of the candidate recommendation schemes 12 is all stored in the player community.

At least one of a recommended player signature 15 and a scheme name 14 is further displayed in the candidate recommendation schemes 12. For example, the recommended player signature is “xx Elixir”, and the scheme name is “xx Elixir Nami Support Strategy”.

3. Display, in response to a selection operation performed on the strategy view control of a target recommendation scheme, a scheme strategy of the target recommendation scheme in the player community.

The target recommendation scheme is any candidate recommendation scheme in the item recommendation scheme that includes the strategy view control.

As shown in part (b) of FIG. 2B, a scheme strategy of the target recommendation scheme in the player community 20 is displayed in response to a selection operation performed on the strategy view control 13 of a target recommendation scheme among the candidate recommendation schemes 12. The scheme strategy includes at least one of virtual object skill information, item strategy information, and virtual object fighting information. In some embodiments, the virtual object skill information may further be referred to as hero skill information, and the virtual object fighting information may further be referred to as hero fighting information. In other words, the scheme strategy includes at least one of the hero skill information, the item strategy information, and the hero fighting information.

In an exemplary embodiment, the scheme name 21 of the target recommendation scheme is consistent with the scheme name of the target recommendation scheme in the player community. For example, if a player sets the scheme name of the target recommendation scheme in the player community as “Team Fight Engine”, the names of the selected target recommendation scheme and the scheme after applying the target recommendation scheme are also “Team Fight Engine”.

Based on the above, according to the item selection method in a virtual environment provided in the embodiments of this application, the computer device is configured to: display the virtual object in the virtual environment; display an item recommendation scheme for the virtual object under a first scheme label in response to a first item selection operation of the virtual object, the item recommendation scheme including a plurality of candidate recommendation schemes, at least one of the candidate recommendation schemes including a strategy view control, the strategy view control being linked to a player community; and display, in response to a selection operation performed on the strategy view control of a target recommendation scheme among the candidate recommendation schemes, a scheme strategy of the target recommendation scheme in the player community. Through the method in the embodiments of this application, the battle preparation system for item selection in a game (such as the MOBA game) is coupled with a player community. When a player selects an item recommendation scheme for a virtual object, the player may directly enter the player community through the strategy view control to learn the strategy of the corresponding item recommendation scheme, which effectively improves association between the battle preparation system and the player community in the game (such as the MOBA game), enriches diversity of gameplay for item selection in the game, and helps improve game experience of the player and thus increase a human-machine interaction rate. In addition, through the display of the item recommendation scheme, exposure of players corresponding to the item recommendation scheme in the game (such as the MOBA game) is further increased. These players may provide scheme support for the game operator, which also reduces pressure on the game operator to maintain the scheme content to some extent.

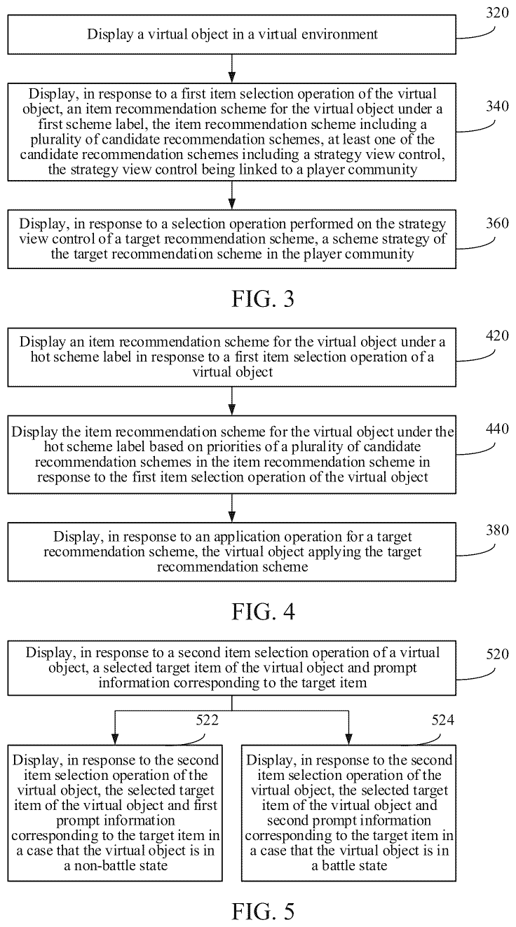

FIG. 3 is a flowchart of an item selection method in a virtual environment according to an exemplary embodiment of this application. The method may be performed by a computer device. The computer device may be the first terminal 120 shown in FIG. 1, or may be the second terminal 160 shown in FIG. 1, and may further be another terminal, or the like. An example in which the method is applied to the first terminal 120 shown in FIG. 1, or the client supporting the virtual environment installed on the first terminal 120, or the second terminal 160, or the client supporting the virtual environment installed on the second terminal 160 is used for description. An example in which the client supporting the virtual environment is a MOBA game is used for description. The item selection method in the virtual environment includes operation 320 to operation 360.

Operation 320: Display a virtual object in a virtual environment.

The virtual environment is a virtual environment displayed or provided when a client runs on a computer device.

In some embodiments, the virtual environment may be a simulated world of a real world, or may be a semi-simulation and semi-fiction three-dimensional world, and may further be a purely fictional three-dimensional world.

Exemplarily, the computer device displays a virtual object in a virtual environment. The virtual object may be in an in-battle battle state, or may be in an out-of-battle non-battle state. The expression “in-battle” refers to being in a game in a virtual environment, and the expression “out-of-battle” refers to being outside the game in the virtual environment.

Operation 340: Display an item recommendation scheme for the virtual object under a first scheme label in response to a first item selection operation of the virtual object, the item recommendation scheme including a plurality of candidate recommendation schemes, at least one of the candidate recommendation schemes including a strategy view control, the strategy view control being linked to a player community.

The first item selection operation is an operation of performing item selection through a battle preparation system. Exemplarily, the first item selection operation is an operation of performing item selection of a virtual object by a player through a battle preparation system in the MOBA game. The first item selection operation is configured to select the whole set of item schemes of the virtual object.

A scheme label is a label set in a battle preparation system of a game. For example, the scheme label is the label set in the battle preparation system of the MOBA game. A scheme label may include at least two scheme labels. A first scheme label is one of the at least two scheme labels. Information of the item recommendation scheme recommended for the virtual object may be displayed under at least one of the at least two scheme labels. Exemplarily, the item recommendation scheme includes a plurality of candidate recommendation schemes, and the information of the item recommendation scheme may include a scheme name of each of the plurality of candidate recommendation schemes, a signature of a scheme recommendation player, an application limiting condition, and the like.

Exemplarily, the at least two scheme labels include a default scheme label and a hot scheme label. Under the default scheme label, officially recommended item recommendation schemes for the game for the virtual object are displayed. Under the hot scheme label, player-recommended item recommendation schemes for the virtual object are displayed. The player herein may refer to a player that needs to select an item for the virtual object at present, or may be another player, which is not limited in the embodiments of this application.

In this embodiment, when content data exists under the hot scheme label, after the player starts the battle preparation system, the first scheme label is the hot scheme label by default. To be specific, the content data under the hot scheme label is displayed by default. In this way, the item scheme recommended by the players can be recommended to a current player, which helps improve diversity of item selection, improve game experience of the current player, and thus increase the human-machine interaction rate.

The item recommendation scheme is one or more item schemes for a virtual object that are recommended to the player for selection. The item scheme includes an item such as a battle item, inscription, skill, or talent.

In some embodiments, the item recommendation scheme may be displayed in the form of a list. The list includes a plurality of candidate recommendation schemes arranged in sequence for the player to select.

The strategy view control is a control configured to be triggered (for example, clicked/tapped) to view the scheme strategy corresponding to the candidate recommendation scheme.

In some embodiments, the strategy view control is linked to the player community. To be specific, the strategy view control is clicked/tapped to view the scheme strategy for the candidate recommendation scheme in the player community.

Exemplarily, the item recommendation scheme includes a plurality of candidate recommendation schemes, at least one of the candidate recommendation schemes including a strategy view control, the strategy view control being linked to a player community.

In some embodiments, the scheme strategy corresponding to the candidate recommendation scheme in the player community may be a scheme strategy uploaded by a live streamer player to a server where the player community is located and passing scheme review. To be specific, the scheme strategy may be maintained by the live streamer player.

In some embodiments, the player community may be a micro-community provided by a client or a game server. Alternatively, the player community may further be an external player community provided by a third-party computer device.

Exemplarily, the computer device displays, in response to a first item selection operation of a virtual object, an item recommendation scheme for the virtual object under the first scheme label, the item recommendation scheme including a plurality of candidate recommendation schemes, at least one of the candidate recommendation schemes including a strategy view control, the strategy view control being linked to a player community.

Operation 360: Display, in response to a selection operation performed on the strategy view control of a target recommendation scheme, a scheme strategy of the target recommendation scheme in the player community.

The target recommendation scheme is any candidate recommendation scheme in the item recommendation scheme that includes the strategy view control. The target recommendation scheme is a candidate recommendation scheme selected by the player.

The selection operation performed on the strategy view control includes a clicking/tapping operation performed on the strategy view control.

In some embodiments, the computer device jumps to the player community in response to the selection operation performed on the strategy view control for the target recommendation scheme among the candidate recommendation schemes, and displays the scheme strategy of the target recommendation scheme in the player community in a virtual environment picture.

Based on the above, according to the item selection method in a virtual environment provided in the embodiments of this application, the computer device is configured to: display the virtual object in the virtual environment; display an item recommendation scheme for the virtual object under a first scheme label in response to a first item selection operation of the virtual object, the item recommendation scheme including a plurality of candidate recommendation schemes, at least one of the candidate recommendation schemes including a strategy view control, the strategy view control being linked to a player community; and display, in response to a selection operation performed on the strategy view control of a target recommendation scheme among the candidate recommendation schemes, a scheme strategy of the target recommendation scheme in the player community. Through the method in the embodiments of this application, the battle preparation system for item selection in a game (such as the MOBA game) is coupled with a player community. When a player selects an item recommendation scheme for a virtual object, the player may directly enter the player community through the strategy view control to learn the strategy of the corresponding item recommendation scheme, which effectively improves association between the battle preparation system and the player community in the game (such as the MOBA game), enriches diversity of gameplay for item selection in the game, and helps improve game experience of the player and thus increase a human-machine interaction rate. In addition, through the display of the item recommendation scheme, exposure of players corresponding to the item recommendation scheme in the game (such as the MOBA game) is further increased. These players may provide scheme support for the game operator, which also reduces pressure on the game operator to maintain the scheme content to some extent.

In some embodiments, when content data exists under the hot scheme label, after the player starts the battle preparation system, the first scheme label is the hot scheme label by default. To be specific, the first scheme label includes the hot scheme label, and the content data under the hot scheme label is displayed by default.

FIG. 4 is a flowchart of an item selection method in a virtual environment according to an exemplary embodiment of this application. In some embodiments, operation 340 may alternatively be implemented as operation 420 below.

Operation 420: Display, in response to a first item selection operation of a virtual object, an item recommendation scheme for the virtual object under a hot scheme label, a plurality of candidate recommendation schemes in the item recommendation scheme including an item scheme of a second account for the virtual object, the second account being an account other than a currently logged-in first account.

The first account is a current account that a current player currently logs in.

The second account is an account of another player other than the first account. Another player is also referred to as a live streamer player, and any player that participates in the game may become a live streamer player. The item scheme of the second account for the virtual object may also be referred to as a live streamer item recommendation scheme.

In an exemplary embodiment, players corresponding to the second account do not include a player corresponding to an account of a first type, a player corresponding to an account of a second type, and a player corresponding to an account of a third type. The account of the first type, the account of the second type, and the account of the third type are the accounts of players that are allowed to recommend item schemes by default in the related art, and the second account is an account of a player that is not allowed to recommend an item scheme by default in the related art. In an exemplary embodiment, in addition to the item scheme of the second account for the virtual object, a plurality of candidate recommendation schemes in the item recommendation scheme may further include at least one of the item scheme of the account of the first type for the virtual object, the item scheme of the account of the second type for the virtual object, and the item scheme of the account of the third type for the virtual object. In other words, the implementation of this application enriches the item schemes for the virtual object, and helps improve diversity of item selection, improve game experience of item selection, and thus increase a human-machine interaction rate. A first type, a second type, and a third type are types of player accounts set based on popularity values in the game, and the popularity values of the account of the first type, the account of the second type, and the account of the third type in the game decrease in sequence. In some embodiments, the player corresponding to the account of the first type may further be referred to as a star, the player corresponding to the account of the second type may further be referred to as a veteran, and the player corresponding to the account of the third type may further be referred to as a popular player.

In some embodiments, the item scheme of the second account for the virtual object is stored in the player community. In other words, data of the live streamer item recommendation scheme is stored in the player community, which may be specifically uploaded by the player to the server where the player community is located. The data included in the live streamer item recommendation scheme includes at least one of a name of the live streamer, an avatar of the live streamer, battle preparation data, and a scheme strategy. The scheme strategy includes at least one of virtual object skill information, item strategy information, and virtual object fighting information.

Exemplarily, a computer device displays the item recommendation scheme for the virtual object under the hot scheme label in response to the first item selection operation of the virtual object.

In this embodiment, the computer device can display the content data of the item recommendation scheme in the player community by displaying the item recommendation scheme for the virtual object under the hot scheme label by default, thereby increasing a coupling degree between the battle preparation system in the game and the player community, and reducing costs for the player to learn an item strategy. The content data under the hot scheme label is displayed by default, so that a problem of a decrease in a frequency of transmission of the content data in the player community as a result of reluctance of some players to switch a label page in the battle preparation system can be reduced, the diversity of item selection can be further improved, the game experience of the current player can be improved, and the human-machine interaction rate can be thus increased.

In addition, a player with the second account may upload and store the item scheme for the virtual object in the player community, so that the player can maintain the item scheme, which improves richness of construction of the item scheme and improves practicability and data credibility of the scheme. These players may further provide scheme support for the game operator, which also reduces the pressure on the game operator to maintain the scheme content to some extent.

In some embodiments, when the item recommendation schemes are displayed in the form of a list, the list includes a plurality of candidate recommendation schemes arranged in sequence. In some embodiments, the plurality of candidate recommendation schemes are ordered based on priorities of the candidate recommendation schemes in the list. Still referring to FIG. 4, in some embodiments, operation 420 may alternatively be implemented as operation 440 below.

Operation 440: Display the item recommendation scheme for the virtual object under the hot scheme label based on priorities of the plurality of candidate recommendation schemes in the item recommendation scheme in response to the first item selection operation of the virtual object, the priorities of the candidate recommendation schemes successively including in descending order: an item scheme of an account of a first type for the virtual object, an item scheme of the second account for the virtual object, an item scheme of an account of a second type for the virtual object, and an item scheme of an account of a third type for the virtual object.

The priorities of the candidate recommendation schemes in the item recommendation scheme are configured for characterizing a display order of the candidate recommendation schemes. A higher priority indicates a higher display order.

The account of the first type, the account of the second type, and the account of the third type are account types divided based on the popularity values of players in a game, and the popularity values of the account of the first type, the account of the second type, and the account of the third type in the game decrease in sequence. In some embodiments, the account of the first type may further be referred to as a star account, the account of the second type may further be referred to as a veteran account, and the account of the third type may further be referred to as a popular account. In other words, the star account, the veteran account, and the popular account are account types divided based on the popularity values of the players in the game, and the popularity values of the star account, the veteran account, and the popular account in the game decrease in sequence.

Exemplarily, the priorities of the candidate recommendation schemes in the related art successively include, in descending order, the item scheme of the account of the first type for the virtual object, the item scheme of the account of the second type for the virtual object, and the item scheme of the account of the third type for the virtual object. The priorities of the candidate recommendation schemes in this embodiment successively include, in descending order: the item scheme of the account of the first type for the virtual object, the item scheme of the second account for the virtual object, the item scheme of the account of the second type for the virtual object, and the item scheme of the account of the third type for the virtual object. In other words, a priority of an item scheme (which may also be referred to as a live streamer item recommendation scheme) of the added second account for the virtual object is lower than the priority of the item scheme of the account of the first type for the virtual object, and higher than the priority of the item scheme of the account of the second type for the virtual object and the priority of the item scheme of the account of the third type for the virtual object. The account of the first type, the second account, the account of the second type, and the account of the third type are parallel accounts.

In other words, the priorities of the candidate recommendation schemes in the related art successively include, in descending order, the item scheme of the star account for the virtual object, the item scheme of the veteran account for the virtual object, and the item scheme of the popular account for the virtual object. The priorities of the candidate recommendation schemes in this embodiment successively include, in descending order: the item recommendation scheme of the star account for the virtual object, the item recommendation scheme of the second account for the virtual object, the item recommendation scheme of the veteran account for the virtual object, and the item recommendation scheme of the popular account for the virtual object. In other words, the priority of the added live streamer item recommendation scheme is lower than the priority of the item recommendation scheme of the star account, and higher than the priority of the item recommendation scheme of the veteran account and the priority of the item recommendation scheme of the popular account. The star account, the second account, the veteran account, and the popular account are parallel accounts.

Exemplarily, the computer device displays the item recommendation scheme for the virtual object under the hot scheme label based on the priorities of the plurality of candidate recommendation schemes in the item recommendation scheme in response to the first item selection operation of the virtual object.

In this embodiment, a plurality of candidate schemes in the item recommendation scheme are displayed based on the priorities, which increases exposure of some item schemes of ordinary players (i.e., players corresponding to the second account), and improves richness of construction of the item scheme, so that the player may feel more involved, thereby improving game experience of the players to some extent.

In an example, the foregoing item recommendation schemes and usage scenarios thereof are described below with reference to FIGS. 2A and 2B.

### 1) Scheme Classification and Priority Adjustment

(a) Replace “Official Recommendations” with “a Default Scheme”

Currently, officially recommended content is inadequate, which represents a default item scheme for a virtual object of a player, and has a poor effect. In addition, the official operator is unable to maintain content data, and there's a possibility that the player is misguided. Therefore, “official recommendations” labels in the game are all replaced with “default schemes” labels.

### (b) Add Item Recommendation Content

Scheme recommendation data of a live streamer is added to a hot scheme label of a battle preparation system, which has a lower priority than that of the star and a higher priority than that of the veteran and the popular player, the data including: at least one of a name of the live streamer, an avatar of the live streamer, battle preparation data, and a scheme introduction (scheme strategy).

### (c) Open the “Hot Scheme” Label by Default

When the player opens a recommendation window of the battle preparation system, when content data exists under the hot scheme label, the hot scheme label is selected and displayed by default, as shown in part (a) of FIG. 2A, to reduce a problem of a decrease in a frequency of content transmission as a result of the reluctance of some players to switch a label page.

### 2) Scheme Name Adjustment

When a live streamer scheme is applied by a player, a scheme name in the player community (micro-community) is to be adopted by default.

In the item recommendation scheme of the battle preparation system, the live streamer scheme needs to carry an entrance to view a strategy to click/tap to jump to the micro-community. For the content of the micro-community, reference may be made to part (b) of FIG. 2B. An item recommendation in a selection interface (hero selection interface) for the virtual object does not carry a link to the entrance to view the strategy.

Exemplarily, FIG. 5 is a flowchart of an item selection method in a virtual environment according to an exemplary embodiment of this application. Based on the foregoing embodiments, the method further includes the following operation 520.

Operation 520: Display, in response to a second item selection operation of a virtual object, a selected target item of the virtual object and prompt information corresponding to the target item, the prompt information being configured for indicating a usage strategy of the target item.

In some embodiments, the prompt information is a short sentence with a length less than a length threshold.

The second item selection operation is an operation of performing item selection through a battle preparation system. Exemplarily, the second item selection operation is an operation of performing item selection of a virtual object by a player through a battle preparation system in a MOBA game. The second item selection operation is configured for selecting one or more independent items of the virtual object.

The target item is an independent item selected by the player.

The prompt information is information for the usage strategy of the target item. In some embodiments, the prompt information is one-sentence prompt information. To be specific, the prompt information is a short sentence with a length less than a length threshold. The length threshold characterizes a maximum length of a statement in the prompt information, which may be set based on actual technical needs. For example, the length threshold may be set to 50 words.

In some embodiments, a computer device displays the selected target item of the virtual object and the prompt information corresponding to the target item in response to a second item selection operation of the virtual object, the prompt information being configured for indicating a usage strategy of the target item. Exemplarily, the prompt information is a short sentence with a length less than a length threshold.

In some embodiments, the prompt information is one-sentence prompt information provided by a KOL for each item in advance, and a game server has the prompt information corresponding to each item stored therein.

In this embodiment, the prompt information corresponding to the selected target item is displayed, so that the player may quickly understand a usage principle, a gameplay skill, and the like of the item. In addition, the prompt information is the short sentence, which is convenient for the player to understand, thereby increasing diversity of gameplay for item selection in a game, and helping improve game experience of the player, and thus increase a human-machine interaction rate.

In some embodiments, still referring to FIG. 5, operation 520 may alternatively be implemented as operation 522.

Operation 522: Display, in response to the second item selection operation of the virtual object, the selected target item of the virtual object and the first prompt information corresponding to the target item when the virtual object is in a non-battle state, the first prompt information floating over a virtual environment picture, the first prompt information carrying a signature, the signature being configured for indicating an information source of the first prompt information.

In some embodiments, the prompt information includes the first prompt information. The first prompt information carries a signature, the signature being configured for indicating the information source of the first prompt information. For example, after a player selects an item, corresponding first prompt information is “If the opponent uses a defending item, I will use this one in response!—a prompt from xxx”. The “prompt from xxx” is a signature, and “xxx” is an information source of the first prompt information.

In some embodiments, when the virtual object is in the non-battle state, the first prompt information that carries a signature is displayed. The first prompt information may float at any position or a fixed position in the virtual environment picture.

Exemplarily, the computer device displays, in response to the second item selection operation of the virtual object, the selected target item of the virtual object and the first prompt information corresponding to the target item when the virtual object is in the non-battle state, the first prompt information floating over a virtual environment picture, the first prompt information carrying a signature, the signature being configured for indicating an information source of the first prompt information.

In some embodiments, still referring to FIG. 5, operation 520 may alternatively be implemented as operation 524.

Operation 524: Display, in response to the second item selection operation of the virtual object, the selected target item of the virtual object and the second prompt information corresponding to the target item when the virtual object is in a battle state, the second prompt information floating over a virtual environment picture, the second prompt information not carrying a signature, the signature being configured for indicating an information source of the second prompt information.

In some embodiments, the prompt information includes the second prompt information. The second prompt information does not carry a signature, the signature being configured for indicating the information source of the second prompt information. For example, after a player selects an item, corresponding second prompt information is “If the opponent uses a defending item, I will use this one in response!”, and the signature is not displayed.

In some embodiments, when the virtual object is in the battle state, the second prompt information that does not carry a signature is displayed. The second prompt information may float at any position or a fixed position in the virtual environment picture.

Exemplarily, the computer device displays, in response to the second item selection operation of the virtual object, the selected target item of the virtual object and the second prompt information corresponding to the target item when the virtual object is in a battle state, the second prompt information floating over a virtual environment picture, the second prompt information not carrying a signature, the signature being configured for indicating an information source of the second prompt information.

In the foregoing embodiments, when the virtual object is in the non-battle state, the first prompt information that carries a signature is displayed, which may further increase exposure of a signed player of the first prompt information in the game while increasing the diversity of gameplay for item selection in the game. In a case that the virtual object is in the battle state, the second prompt information that does not carry a signature is displayed, which may further avoid, in some scenarios, the exposure of the signed player in the game while increasing the diversity of gameplay for item selection in the game. For example, in a live streaming scene of a game, when a signed player and a live streaming player are not the same player, the signed player may be prevented from being promoted in a live streaming process of the live streaming player, so that the live streaming process is beneficial to the live streaming player.

In an example, the foregoing prompt information and usage scenarios thereof are described below in combination with specific schematic diagrams.

### 1) Prompt Information Specification

From a perspective of a player hub, players often show special preference to some articles that explain usage scenarios of the item in one sentence. In this embodiment, considering subsequent data maintenance and a collaborative ecosystem between an official platform and a KOL, the prompt information specification is determined as a one-sentence description of usage scenario prompt information (tips) for the item provided by the KOL, and the KOL is given the right to sign.

### 2) Prompt Information Scene

### (I) Out-of-Battle Battle Preparation System

A display region floating over an item information panel is added to the out-of-battle battle preparation system to display one-sentence prompt information of the item with a signature.

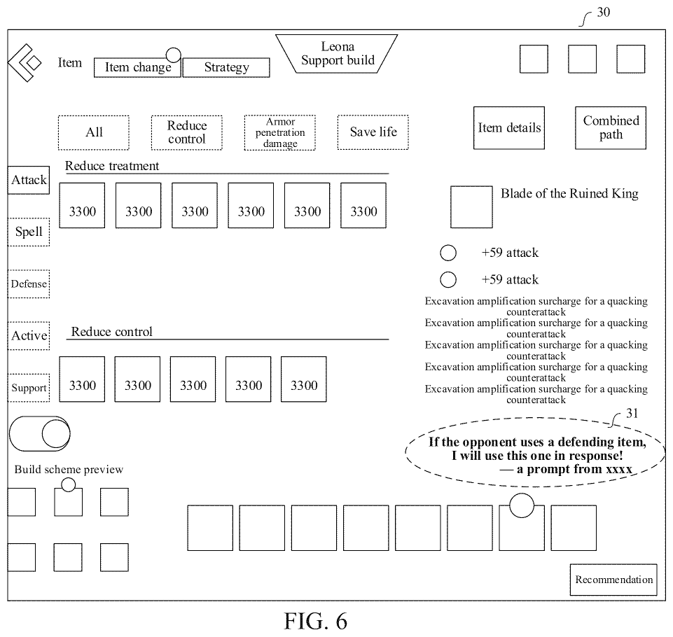

FIG. 6 is a schematic diagram of an item selection method in a virtual environment according to an exemplary embodiment of this application. In a display picture 30 of an out-of-battle battle preparation system, one-sentence prompt information of the item with a signature is displayed in the display region 31, i.e., “If the opponent uses a defending item, I will use this one in response!—a prompt from xxxx”. “Out-of-battle” refers to being outside a game in the virtual environment. When a player is outside a game, the virtual object is in a non-battle state.

### (II) In-Battle Item Store

Content floating over an item information panel is added to the in-battle item store to display one-sentence prompt information of the item without a signature.

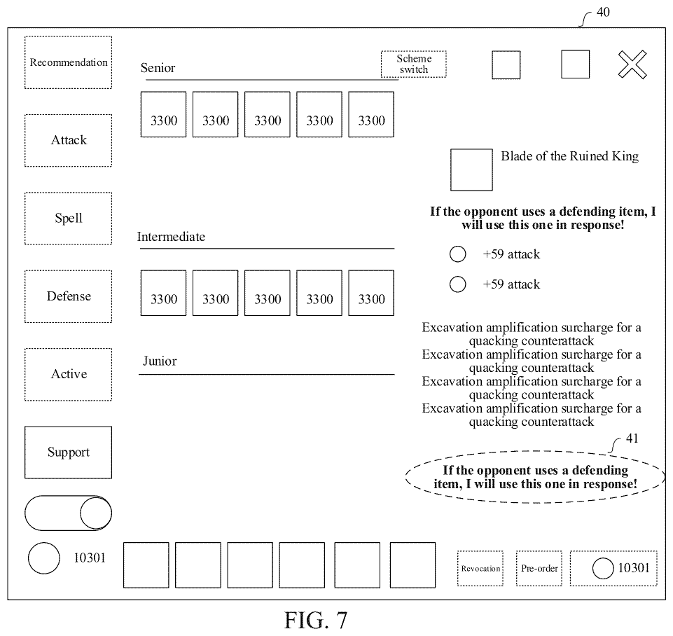

FIG. 7 is a schematic diagram of an item selection method in a virtual environment according to an exemplary embodiment of this application. In a display picture 40 of an in-battle item store, one-sentence prompt information of the item without a signature is displayed in a display region 41, i.e., “If the opponent uses a defending item, I will use this one in response”. “In-battle” refers to being in a game in the virtual environment. When a player is in a game, the virtual object is in a battle state.

### (III) Current Item Information

One-sentence prompt information of a usage scenario of the item is independently displayed in a reference orientation (for example, below, left, right, or above) of a frame of the current item information.

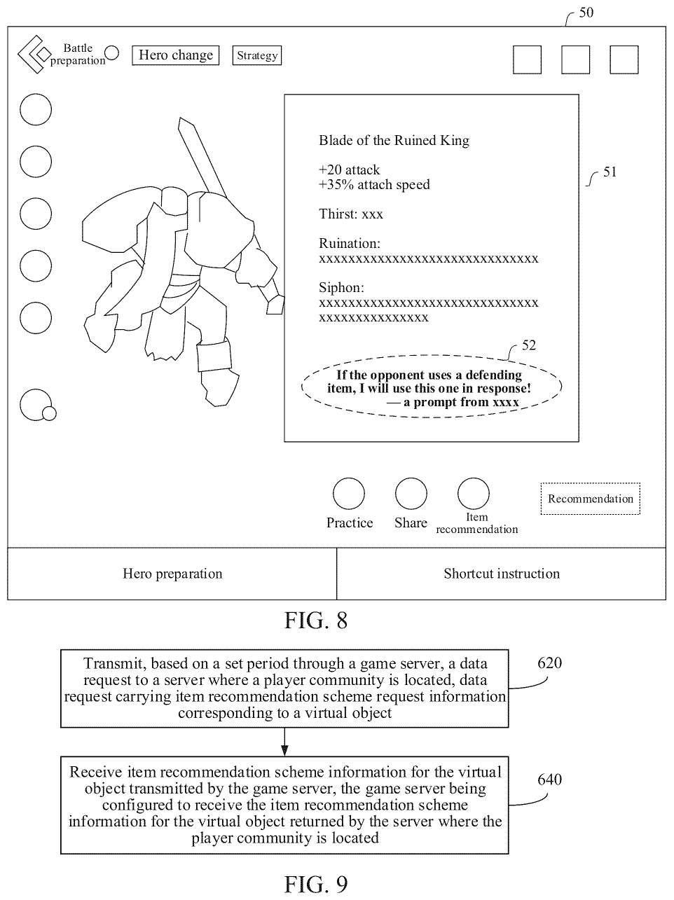

FIG. 8 is a schematic diagram of an item selection method in a virtual environment according to an exemplary embodiment of this application. In a display picture 50 of a current item of a virtual object viewed by a player, one-sentence prompt information 52 with a signature of the item is displayed in a display region 51, i.e., “If the opponent uses a defending item, I will use this one in response!—a prompt from xxxx”. When the player views the current item, the virtual object is in a non-battle state.

In some embodiments, w % ben a player selects a target recommendation scheme from candidate recommendation schemes, the player may apply the target recommendation scheme. Still referring to FIG. 4, based on operation 360, the method may alternatively include the following operation 380.

Operation 380: Display, in response to an application operation for a target recommendation scheme, the virtual object applying the target recommendation scheme.

Exemplarily, a display name of the target recommendation scheme includes a scheme name corresponding to the target recommendation scheme in a player community.

In some embodiments, each candidate recommendation scheme includes an application control. The application control is configured to be triggered (clicked/tapped) to apply the candidate recommendation scheme to the virtual object.

An application operation refers to an operation of triggering (for example, clicking/tapping) the application control of the candidate recommendation scheme.

In some embodiments, after the virtual object applies the target recommendation scheme, the display name of the target recommendation scheme is still the scheme name corresponding to the target recommendation scheme in the player community. For example, referring to part (b) of FIG. 2B, if a name of the target recommendation scheme selected by a player is “Team Fight Engine” in the player community, the scheme name is still displayed as “Team Fight Engine” after the player applies the target recommendation scheme to the virtual object.

Exemplarily, a computer device displays, in response to the application operation for the target recommendation scheme among the candidate recommendation schemes, the virtual object applying the target recommendation scheme. Exemplarily, a display name of the target recommendation scheme includes a scheme name corresponding to the target recommendation scheme in a player community.

In some embodiments, the player is allowed to modify the scheme name of the target recommendation scheme. After the target recommendation scheme is applied, the computer device displays, in response to the name modification operation, the target recommendation scheme with a modified scheme name.

In this embodiment, the scheme name of the target recommendation scheme in the player community is displayed, which may further increase a coupling degree between the battle preparation system in the game and the player community, and strengthen the connection between the player community and the game, so that the content data in the player community can be effectively transmitted.

FIG. 9 is a flowchart of an item selection method in a virtual environment according to an exemplary embodiment of this application. Based on the foregoing embodiments, the method may alternatively include the following operation 620 and operation 640.

Operation 620: Transmit, based on a set period through a game server, a data request to a server where a player community is located, the data request carrying item recommendation scheme request information corresponding to a virtual object.

The game server refers to a game platform server.

The data request is the data request sent by the game server to the server where the player community is located. The data request carries item recommendation scheme request information corresponding to a virtual object of a current to-be-selected item. The virtual object of the current to-be-selected item refers to the virtual object currently selected by the player, i.e., the virtual object displayed in operation 320.

In some embodiments, the data request carries the item recommendation scheme request information corresponding to each virtual object, and each virtual object includes the virtual object of the current to-be-selected item.

In some embodiments, the item recommendation scheme request information includes a request to obtain at least one of a name of an item recommendation player, an avatar of the item recommendation player, battle preparation data, and a scheme strategy. In some embodiments, the item recommendation player may further be referred to as a live streamer, and the item recommendation scheme request information includes a request to obtain at least one of a name of the live streamer, an avatar of the live streamer, the battle preparation data, and the scheme strategy.

A period is a period of transmitting the data request. A duration of the period may be set based on an actual technical need. For example, the duration is set to transmission once every 20 minutes.

In some embodiments, the computer device (a client background) transmits, based on a set period through a game server, a data request to a server where a player community is located, the data request carrying item recommendation scheme request information corresponding to the virtual object of the current to-be-selected item. In a possible implementation, the data request carries the item recommendation scheme request information corresponding to each virtual object. Each virtual object refers to all types of virtual objects in a game. In other words, each virtual object includes the virtual object of the current to-be-selected item.

In another possible implementation, the data request is generated based on a type of a virtual object which has been selected within a recent period by a current player more than a threshold number of times. The data request carries the item recommendation scheme request information corresponding to the virtual object which has been selected within the recent period by the current player more than the threshold number of times. The number of selection times exceeding the threshold of the number of times characterizes that the current player often uses this type of virtual object in the game. The virtual object which has been selected within the recent period by the current player more than the threshold number of times includes the virtual object of the current to-be-selected item. The recent time period may be set based on the actual technical need. For example, the recent time period may refer to recent 30 days, or may refer to recent 7 days, or the like.

In some embodiments, the player community may be a micro-community provided by a client or a game server. Alternatively, the player community may further be an external player community provided by a third-party computer device.

Operation 640: Receive item recommendation scheme information for the virtual object transmitted by the game server, the game server being configured to receive the item recommendation scheme information for the virtual object returned by the server where the player community is located.

In some embodiments, the game server is further configured to store item recommendation scheme information.

In some embodiments, the game server is configured to receive the item recommendation scheme information corresponding to each virtual object returned by the server where the player community is located, and store the item recommendation scheme information. Each virtual object includes the virtual object of the current to-be-selected item. Exemplarily, the computer device receives the item recommendation scheme information for the virtual object transmitted by the game server, thereby displaying an item recommendation scheme for the virtual object under a first scheme label in response to a first item selection operation of the virtual object.

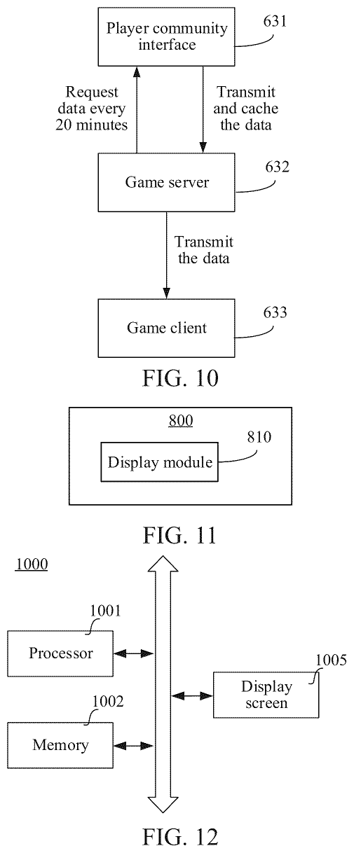

In an example, FIG. 10 is a schematic diagram of an item selection method in a virtual environment according to an exemplary embodiment of this application. The embodiments of this application relate to a server where a player community is located, a game server 632, and a game client 633. The server where the player community is located provides a player community interface 631.

The game server 632 transmits, based on the player community interface 631 every 20 minutes, a data request to the server where the player community is located. The data request carries item recommendation scheme request information of each virtual object in the game.

The game server 632 receives the item recommendation scheme request information of each virtual object returned by the server where the player community is located, and stores the item recommendation scheme request information.

The game server 632 transmits, to the game client 633, item recommendation scheme information for the virtual object selected by the player.

In this embodiment, compared with a case that the data request is transmitted to the server where the player community is located every time content data in the player community needs to be obtained in the related art, the game server transmits the data request to the server where the player community is located based on the set period, and stores the returned corresponding information, which can alleviate the server pressure when a plurality of computer devices simultaneously transmit the data request to the server where the player community is located through the game server. The game server stores the item recommendation scheme information of each virtual object to quickly transmit the corresponding item recommendation scheme information for one virtual object, thereby improving data processing efficiency.

In some embodiments, a neural network model is stored in a terminal or a client. In a case that a player selects a virtual object, the item recommendation scheme information for the virtual object in the player community is inputted into the neural network model, to determine the item recommendation scheme for the virtual object. The item recommendation scheme includes a plurality of candidate recommendation schemes.

In some embodiments, the neural network model is trained based on a plurality of sets of sample data, the sample data including input data and label data. The input data includes at least a first item recommendation scheme of an ally virtual object, the first item recommendation scheme including at least one of grade, type, attribute, skill, talent, and inscription of the ally virtual object, and a second item recommendation scheme of an enemy virtual object, the second item recommendation scheme including at least one of grade, type, attribute, skill, talent, and inscription of the enemy virtual object. The label data includes at least first item recommendation scheme information of the ally virtual object for the second item recommendation scheme of the enemy virtual object having a restraining effect, and third item recommendation scheme information of an ally second virtual object for a first item recommendation scheme of an ally first virtual object having a buff effect.

In some embodiments, the input data of the neutral network model further includes first battle data of the ally virtual object configured with a first item recommendation scheme during a battle of the ally virtual object, the first battle data including at least one of an ally battle win rate, an ally on-line battle win rate, a team participation rate, an attack assistance rate, an output damage value, a number of towers destroyed, and a number of last hits within a set historical time period, and second battle data of the enemy virtual object configured with a second item recommendation scheme during a battle of the enemy virtual object, the second battle data including at least one of an enemy battle win rate, an enemy on-line battle win rate, a team participation rate, an attack assistance rate, an output damage value, a number of towers destroyed, and a number of last hits within the set historical period.

In some embodiments, after the item recommendation scheme for the virtual object is determined, priorities of the plurality of candidate recommendation schemes are determined based on at least one of restraining effects, buffs, and battle data corresponding to the plurality of candidate recommendation schemes in the item recommendation scheme, so that the computer device can display the item recommendation scheme based on the priorities.

Exemplarily, in the plurality of candidate recommendation schemes in item recommendation scheme, a higher restraining effect against the enemy virtual object, a higher buff effect for the ally virtual object, or at least one of a higher ally battle win rate, a higher ally on-line battle win rate, a higher team participation rate, a higher attack assistance rate, a higher output damage value, a higher number of towers destroyed, and a higher number of last hits in the battle data indicates a higher corresponding priority.

Based on the foregoing embodiments, intelligent recommendation of the item recommendation scheme for the virtual object may be implemented based on the neural network model, and the item recommendation schemes are all stored in the player community, which further improves the association between the player community and the battle preparation system in the game, and may further improve recommendation efficiency of the item recommendation scheme.

FIG. 11 is a structural block diagram of an item selection apparatus in a virtual environment according to an exemplary embodiment of this application. The item selection apparatus 800 in the virtual environment includes
a display module 810, configured to display a virtual object in the virtual environment.

The display module 810 is configured to display an item recommendation scheme for the virtual object under a first scheme label in response to a first item selection operation of the virtual object, the item recommendation scheme including a plurality of candidate recommendation schemes, at least one of the candidate recommendation schemes including a strategy view control, the strategy view control being linked to a player community, and the first item selection operation being an operation of performing item selection through a battle preparation system.

The display module 810 is configured to display, in response to a selection operation performed on the strategy view control of a target recommendation scheme, a scheme strategy of the target recommendation scheme in the player community, the target recommendation scheme being any candidate recommendation scheme in the item recommendation scheme that includes the strategy view control.

In some embodiments, the first scheme label includes a hot scheme label.

In some embodiments, the display module 810 is configured to display the item recommendation scheme for the virtual object under the hot scheme label in response to the first item selection operation of the virtual object, the plurality of candidate recommendation schemes in the item recommendation scheme including an item scheme of a second account for the virtual object, the second account being an account other than a currently logged-in first account.

In some embodiments, the display module 810 is configured to display the item recommendation scheme for the virtual object under the hot scheme label based on priorities of the plurality of candidate recommendation schemes in the item recommendation scheme in response to the first item selection operation of the virtual object, the priorities of the candidate recommendation schemes successively including in descending order: an item scheme of an account of a first type for the virtual object, an item scheme of the second account for the virtual object, an item scheme of an account of a second type for the virtual object, and an item scheme of an account of a third type for the virtual object, popularity values of the account of the first type, the account of the second type, and the account of the third type in a game decreasing in sequence.

In some embodiments, the item scheme of the second account for the virtual object is stored in the player community.

In some embodiments, the apparatus further includes a prompt module.

In some embodiments, the prompt module is configured to display, in response to a second item selection operation of the virtual object, a selected target item of the virtual object and prompt information corresponding to the target item, the prompt information being configured for indicating a usage strategy of the target item.

In some embodiments, the prompt information is a short sentence with a length less than a length threshold.

In some embodiments, the prompt information includes first prompt information. The prompt module is configured to display, in response to the second item selection operation of the virtual object, the selected target item of the virtual object and the first prompt information corresponding to the target item when the virtual object is in a non-battle state, the first prompt information floating over a virtual environment picture, the first prompt information carrying a signature, the signature being configured for indicating an information source of the first prompt information.

In some embodiments, the prompt information includes second prompt information. The prompt module is configured to display, in response to the second item selection operation of the virtual object, the selected target item of the virtual object and the second prompt information corresponding to the target item when the virtual object is in a battle state, the second prompt information floating over a virtual environment picture, the second prompt information not carrying a signature, the signature being configured for indicating an information source of the second prompt information.

In some embodiments, the display module 810 is further configured to display, in response to an application operation for the target recommendation scheme, the virtual object applying the target recommendation scheme.

In some embodiments, a display name of the target recommendation scheme includes a scheme name corresponding to the target recommendation scheme in the player community.

In some embodiments, the apparatus further includes a transmitting module. The transmitting module is configured to transmit, based on a set period through a game server, a data request to a server where the player community is located, the data request carrying item recommendation scheme request information corresponding to the virtual object.

In some embodiments, the apparatus further includes a receiving module. The receiving module is configured to receive item recommendation scheme information for the virtual object transmitted by the game server, the game server being configured to receive the item recommendation scheme information for the virtual object returned by the server where the player community is located.

For specific limitations in one or more embodiments of the item selection apparatus in the virtual environment provided above, reference may be made to the limitation on the item selection method in a virtual environment described above. Details are not described again herein. The foregoing modules of the apparatus may be implemented entirely or partially by a software, a hardware, or a combination thereof. The foregoing modules may be embedded in or independent of a processor of a computer device in a form of hardware, or may be stored in a memory of the computer device in a form of software, so that the processor invokes each of the foregoing modules to perform an operation corresponding to the module.

FIG. 12 is a schematic structural diagram of a computer device according to an exemplary embodiment of this application.

The computer device 1000 may be a portable mobile terminal, for example, a smartphone, a tablet computer, a moving picture experts group audio laver III (MP3) player, or a moving picture experts group audio layer IV (MP4) player. The computer device 1000 may further be referred to as another name such as a user equipment or a portable terminal.

Generally, the computer device 1000 includes a processor 1001 and a memory 1002.

The processor 1001 may include one or more processing cores, for example, a 4-core processor or an 8-core processor. The processor 1001 may be implemented in at least one hardware form of digital signal processing (DSP), a field programmable gate array (FPGA), and a programmable logic array (PLA). The processor 1001 may also include a main processor and a coprocessor. The main processor is a processor configured to process data in an awake state, and is also referred to as a central processing unit (CPU). The coprocessor is a low-power processor configured to process data in a standby state. In some embodiments, the processor 1001 may be integrated with a graphics processing unit (GPU). The GPU is configured to render and draw content that needs to be displayed on a display screen. In some embodiments, the processor 1001 may further include an AI processor The AI processor is configured to process computing operations related to machine learning.

The memory 1002 may include one or more computer-readable storage media. The computer-readable storage medium may be tangible and non-transient. The memory 1002 may further include a high-speed random access memory (RAM) and a nonvolatile memory, for example, one or more disk storage devices or flash storage devices. In some embodiments, the non-transitory computer-readable storage medium in the memory 1002 is configured to store at least one instruction, the at least one instruction being configured to be executed by the processor 1001, to cause the computer device to implement the item selection method in a virtual environment provided in the embodiments of this application.

In some embodiments, the computer device 1000 may further include a display screen 1005.

The display screen 1005 is configured to display a user interface (UI). The UI may include a graph, texts, an icon, a video, and any combination thereof. When the display screen 1005 is a touch display screen, the display screen 1005 further has a capability of collecting a touch signal on or above a surface of the display screen 1005. The touch signal may be inputted to the processor 1001 as a control signal for processing. In this case, the display screen 1005 may be further configured to provide a virtual button and/or a virtual keyboard, which are/is also referred to as a soft button and/or a soft keyboard. In some embodiments, one display screen 1005 may be arranged on a front panel of the computer device 1000. In some other embodiments, there may be at least two display screens 1005 disposed on different surfaces of the computer device 1000 or folded. In some embodiments, the display screen 1005 may be a flexible display screen arranged on a curved surface or a folded surface of the computer device 1000. The display screen 1005 may be even arranged as a non-rectangular irregular figure, namely, a special-shaped screen. The display screen 1005 may be manufactured by using a liquid crystal display (LCD), an organic light-emitting diode (OLED), or the like. Exemplarily, the virtual object, the item recommendation scheme, the scheme strategy, and the like are displayed through the display screen 1005.

A person skilled in the art may understand that the structure shown in FIG. 12 does not constitute a limitation on the computer device 1000, and the computer device may include more or fewer components than those shown in the figure, or some merged components, or different component arrangements.

In an exemplary embodiment, this application provides a chip, the chip including a programmable logic circuit and/or a program instruction, the chip, when run on a computer device, being configured to cause the processor to implement the item selection method in a virtual environment provided in the foregoing method embodiments.

This application provides a non-transitory computer-readable storage medium, the non-transitory computer-readable storage medium having a computer program stored therein, the computer program being loaded and executed by a processor to cause the processor to implement the item selection method in a virtual environment provided in the foregoing method embodiments.

This application provides a computer program product or a computer program, the computer program product or the computer program including a computer instruction, the computer instruction being stored in a computer-readable storage medium. A processor of a computer device is configured to read the computer instruction from the computer-readable storage medium. The processor is configured to execute the computer instruction, to cause the computer device to perform the item selection method in a virtual environment provided in the foregoing method embodiments.

A person of ordinary skill in the art may understand that all or part of the operations of implementing the foregoing embodiments may be implemented by hardware, or may be implemented by a program instructing related hardware. The program may be stored in a non-transitory computer-readable storage medium. The non-transitory computer-readable storage medium mentioned above may be a read-only memory, a magnetic disk, an optical disc, or the like.

A person skilled in the art is to be aware that in the one or more examples, the functions described in the embodiments of this application may be implemented by hardware, software, firmware, or any combination thereof. When implemented using software, the functions may be stored in the non-transitory computer-readable storage medium or transmitted as one or more instructions or code in the non-transitory computer-readable storage medium. The non-transitory computer-readable medium includes a computer storage medium and a communication medium. The communication medium includes any medium that facilitates transmission of a computer program from one place to another. The storage medium may be any available medium accessible to a general-purpose or special-purpose computer.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely embodiments of this application, but are not intended to limit this application. Any modification, equivalent replacement, or improvement made within the principle of this application shall fall within the protection scope of this application.

What is claimed is:

1. An item selection method in a virtual environment performed by a computer device, the method comprising:
displaying a virtual object in the virtual environment;
in response to a first item selection operation of the virtual object, displaying an item recommendation scheme for the virtual object under a first scheme label, the item recommendation scheme comprising a plurality of candidate recommendation schemes, at least one of the candidate recommendation schemes comprising a strategy view control, and the strategy view control being linked to a player community; and
in response to a selection operation performed on the strategy view control of a target recommendation scheme, displaying a scheme strategy of the target recommendation scheme in the player community, the target recommendation scheme being any candidate recommendation scheme in the item recommendation scheme that comprises the strategy view control.

2. The method according to claim 1, wherein the first scheme label comprises a hot scheme label; and the displaying an item recommendation scheme for the virtual object under a first scheme label comprises:
displaying the item recommendation scheme for the virtual object under the hot scheme label,
the plurality of candidate recommendation schemes in the item recommendation scheme comprising an item scheme of a second account for the virtual object, the second account being an account other than a currently logged-in first account.

3. The method according to claim 2, wherein the displaying the item recommendation scheme for the virtual object under the hot scheme label comprises:
displaying the item recommendation scheme for the virtual object under the hot scheme label based on priorities of the plurality of candidate recommendation schemes in the item recommendation scheme,
the priorities of the candidate recommendation schemes successively comprising in descending order: an item scheme of an account of a first type for the virtual object, an item scheme of the second account for the virtual object, an item scheme of an account of a second type for the virtual object, and an item scheme of an account of a third type for the virtual object, popularity values of the account of the first type, the account of the second type, and the account of the third type in a game decreasing in sequence.

4. The method according to claim 2, wherein the item scheme of the second account for the virtual object is stored in the player community.

5. The method according to claim 1, further comprising:
in response to a second item selection operation of the virtual object, displaying a selected target item of the virtual object and prompt information corresponding to the target item, the prompt information being configured for indicating a usage strategy of the target item.

6. The method according to claim 5, wherein the prompt information is a short sentence with a length less than a length threshold.

7. The method according to claim 5, wherein the prompt information comprises a first prompt information; and the displaying a selected target item of the virtual object and prompt information corresponding to the target item comprises:
displaying the selected target item of the virtual object and the first prompt information corresponding to the target item when the virtual object is in a non-battle state,
the first prompt information floating over a virtual environment picture, the first prompt information carrying a signature, the signature being configured for indicating an information source of the first prompt information.

8. The method according to claim 5, wherein the prompt information comprises a second prompt information; and the displaying a selected target item of the virtual object and prompt information corresponding to the target item comprises:
displaying the selected target item of the virtual object and the second prompt information corresponding to the target item when the virtual object is in a battle state,
the second prompt information floating over a virtual environment picture, the second prompt information not carrying a signature, the signature being configured for indicating an information source of the second prompt information.

9. The method according to claim 1, further comprising:
in response to an application operation for the target recommendation scheme, displaying the virtual object applying the target recommendation scheme.

10. The method according to claim 1, wherein a display name of the target recommendation scheme comprises a scheme name corresponding to the target recommendation scheme in the player community.

11. The method according to claim 1, further comprising:
transmitting, within a preset period through a game server, a data request to a server where the player community is located, the data request carrying item recommendation scheme request information corresponding to the virtual object; and
receiving item recommendation scheme information for the virtual object transmitted by the game server, the game server being configured to receive the item recommendation scheme information for the virtual object returned by the server where the player community is located.

12. A computer device, comprising: a processor and a memory, the memory having computer programs stored therein, the computer programs, when executed by the processor, causing the computer device to perform an item selection method in a virtual environment including:
displaying a virtual object in the virtual environment;
in response to a first item selection operation of the virtual object, displaying an item recommendation scheme for the virtual object under a first scheme label, the item recommendation scheme comprising a plurality of candidate recommendation schemes, at least one of the candidate recommendation schemes comprising a strategy view control, and the strategy view control being linked to a player community; and
in response to a selection operation performed on the strategy view control of a target recommendation scheme, displaying a scheme strategy of the target recommendation scheme in the player community, the target recommendation scheme being any candidate recommendation scheme in the item recommendation scheme that comprises the strategy view control.

13. The computer device according to claim 12, wherein the first scheme label comprises a hot scheme label; and the displaying an item recommendation scheme for the virtual object under a first scheme label comprises:
displaying the item recommendation scheme for the virtual object under the hot scheme label,
the plurality of candidate recommendation schemes in the item recommendation scheme comprising an item scheme of a second account for the virtual object, the second account being an account other than a currently logged-in first account.

14. The computer device according to claim 13, wherein the displaying the item recommendation scheme for the virtual object under the hot scheme label comprises:
displaying the item recommendation scheme for the virtual object under the hot scheme label based on priorities of the plurality of candidate recommendation schemes in the item recommendation scheme,
the priorities of the candidate recommendation schemes successively comprising in descending order: an item scheme of an account of a first type for the virtual object, an item scheme of the second account for the virtual object, an item scheme of an account of a second type for the virtual object, and an item scheme of an account of a third type for the virtual object, popularity values of the account of the first type, the account of the second type, and the account of the third type in a game decreasing in sequence.

15. The computer device according to claim 13, wherein the item scheme of the second account for the virtual object is stored in the player community.

16. The computer device according to claim 12, wherein the method further comprises:
in response to a second item selection operation of the virtual object, displaying a selected target item of the virtual object and prompt information corresponding to the target item, the prompt information being configured for indicating a usage strategy of the target item.

17. The computer device according to claim 16, wherein the prompt information comprises a first prompt information; and the displaying a selected target item of the virtual object and prompt information corresponding to the target item comprises:
displaying the selected target item of the virtual object and the first prompt information corresponding to the target item when the virtual object is in a non-battle state,
the first prompt information floating over a virtual environment picture, the first prompt information carrying a signature, the signature being configured for indicating an information source of the first prompt information.

18. The computer device according to claim 16, wherein the prompt information comprises a second prompt information; and the displaying a selected target item of the virtual object and prompt information corresponding to the target item comprises:
displaying the selected target item of the virtual object and the second prompt information corresponding to the target item when the virtual object is in a battle state,
the second prompt information floating over a virtual environment picture, the second prompt information not carrying a signature, the signature being configured for indicating an information source of the second prompt information.

19. The computer device according to claim 12, wherein the method further comprises:
transmitting, within a preset period through a game server, a data request to a server where the player community is located, the data request carrying item recommendation scheme request information corresponding to the virtual object; and
receiving item recommendation scheme information for the virtual object transmitted by the game server, the game server being configured to receive the item recommendation scheme information for the virtual object returned by the server where the player community is located.

20. A non-transitory computer-readable storage medium, having computer programs stored therein, the computer programs, when executed by a processor of a computer device, causing the computer device to implement an item selection method in a virtual environment including:
displaying a virtual object in the virtual environment;
in response to a first item selection operation of the virtual object, displaying an item recommendation scheme for the virtual object under a first scheme label, the item recommendation scheme comprising a plurality of candidate recommendation schemes, at least one of the candidate recommendation schemes comprising a strategy view control, and the strategy view control being linked to a player community; and
in response to a selection operation performed on the strategy view control of a target recommendation scheme, displaying a scheme strategy of the target recommendation scheme in the player community, the target recommendation scheme being any candidate recommendation scheme in the item recommendation scheme that comprises the strategy view control.
